(19) United States
(12) Patent Application Publication
(10) Pub. No.: US 2012/0263979 A1
(43) Pub. Date: Oct. 18, 2012

(54) BATTERY HOLDER CAPABLE OF INDICATING USABILITY STATUS OF THE BATTERIES

(76) Inventors: Christopher Jensen, Beaverton, OR (US); Kimi Jensen, Beaverton, OR (US)

(21) Appl. No.: 13/088,201

(22) Filed: Apr. 15, 2011

(51) Int. Cl. H01M 10/48; H01M 2/10

(52) U.S. Cl. 429/50; 429/90

(57) ABSTRACT

Apparatuses and methods for portable storage of disposable or rechargeable batteries are disclosed. The battery holder can have several battery compartments, each being suitable for securely holding a battery of a certain size. Additionally, the battery holder has visible indicia instructing a user as to how to orient the battery in the compartment depending on whether the battery is empty or full. Thus, the orientation of the battery in the holder signals battery's empty/full status to the user. The battery compartments can be arranged in one or more rows, circularly, or in a honeycomb orientation. The battery holder can be made of elastic material capable of securely keeping the battery in place. The battery compartments for round batteries can have a non-round cross section, thus enabling air escape from the compartment as the battery is inserted. The compartments can be slightly conical along the axis (draft tapered walls), therefore capable of securing batteries having somewhat different sizes due to tolerances. A lid for covering batteries can be attached with the battery holder. The battery holder can have a tab for keychain attachment.

### BACKGROUND OF THE INVENTION

The present invention generally relates to portable battery storage devices and methods for their use. Exemplary embodiments of the invention provide devices and methods for storing batteries in accordance with their full or empty status.

Dry cell batteries are well known household items. They provide a source of electrical current for common items such as flashlights, computer game consoles, compact disc players, digital cameras, and many other devices. The batteries come in different sizes known as AA, AAA, C, D, etc. Batteries are shaped either as cylinders or parallelepipeds. Unfortunately, the users are frequently unsure about the usability of the battery, i.e. whether a battery is full or empty, because batteries do not have readily available indication of their full/empty charge status. Thus, a potential battery user is often left with a question whether a particular battery is usable or not. Furthermore, a convenient and compact storage for the batteries is also frequently not available.

A variety of devices for storing batteries exist in the field. Some devices have separated compartments for storing full and empty batteries. Therefore, a usability status of the battery is known by the location of the battery in a particular compartment within the storage device. However, these devices are bulky and, depending on a particular mix of empty and full batteries, they can have large proportion of unused storage space.

Some other devices have battery storage that is irreversibly changed by the act of removal of a full battery from the package. Therefore, even though the geometry of a battery compartment could make it useful for either a full or empty battery, once the original battery is removed from a given compartment, that compartment is supposed to house only an empty battery, if at all. In such a package a full battery is not stored back in the battery compartment, because the full battery would be mistaken for an empty battery. Hence, that device only provides storage for empty batteries and the original, but not the replacement, full batteries.

Yet some other devices provide for storage of different sizes of the batteries, but the batteries are arranged such that they make electrical contact in serial or parallel fashion. That device can output electrical current through the attached electrodes, but the usability status of the batteries is not available.

Therefore, a need remains for a portable battery storage devices capable of signaling usability status of a battery in the storage. It would be particularly beneficial if such battery storage devices could provide high degree of utilization of the available battery storage compartments.

### BRIEF SUMMARY OF THE INVENTION

The invention is generally directed toward a battery holder for portable storage of disposable or rechargeable batteries. The battery holder can have several battery compartments, each suitable for securely holding a battery of a certain size. Additionally, the battery holder has visible indicia instructing a user as to how to orient the battery in the compartment depending on whether the battery is empty or full. Thus, the orientation of the battery in the holder signals battery's empty or full status to the user. The battery compartments for round batteries can have a non-round cross section, thus enabling air escape from the compartment as the battery is inserted. The compartments can be slightly conical along the axis (draft tapered walls), therefore capable of securing batteries having somewhat different sizes due to tolerances. The battery holder can be made of elastic material for securely keeping the battery in place. The battery compartments can be arranged in one or more rows, circularly, or in a honeycomb orientation. A lid for covering batteries can be attached with the battery holder. The battery holder can have a tab for keychain attachment.

In one embodiment, a device for storing batteries has: at least one battery compartment for holding a battery; the battery compartment further has an opening for inserting the battery and substantially vertical walls for containing the battery. The device has a battery orientation indicia affixed to the battery compartment to indicate a first battery orientation for a full battery and a second battery orientation for an empty battery, such that the battery is stored in the battery compartment in the first orientation if the battery is full or in the second orientation if the battery is empty.

In one aspect, the battery orientation indicia is chosen from a group consisting of a battery icon oriented downwards, a battery icon oriented upwards, letter E, letter F, white battery, black battery, green battery, red battery, solid battery icon, hatched battery icon, non-crossed out battery icon, crossed out battery icon, or a combination thereof.

In another aspect, the battery compartment is made of elastic polymer capable of deforming when the battery is inserted in the compartment, thus securely holding the battery in place.

In yet another aspect, the device further has one or more air vents for air escape when the battery is inserted or removed, thus making the battery insertion or removal easier.

In another aspect, the walls have a wall draft, thus improving a holding grip on the battery inserted into said battery holder.

In another aspect, the device further has an arrangement of the battery compartments which is chosen from a group consisting of a honeycomb arrangement, a circular arrangement, two or more substantially parallel columns, or a combination thereof.

In another aspect, the device further has a cap adapted and configured to engage with the walls around the opening, thus covering the battery in the battery compartment.

In another embodiment, a method for storing batteries has the steps of: determining full or empty status of a battery, reading a battery orientation indicia from a battery holder, and inserting the battery into the battery holder in a first direction if said battery is full, or in a second direction if said battery is empty.

In one aspect, the method has a further step of attaching a cap on the battery holder, thus further securing the battery in the battery holder.

In another embodiment, a method for determining full or empty status of batteries, has the steps of: ascertaining an orientation of a battery inside a battery holder, reading a battery orientation indicia from the battery holder, and comparing the orientation of the battery to the battery orientation indicia to determine if the battery is full or empty.

For further understanding of the nature and advantages of the invention, reference should be made to the following description taken in conjunction with the accompanying figures. It is to be expressly understood, however, that each of the figures is provided for the purpose of illustration and description only and is not intended as a definition of the limits of the embodiments of the present invention.

### BRIEF DESCRIPTION OF THE DRAWINGS

FIG. 1 shows a front and back plan view illustrating one embodiment of the battery holder.

FIGS. 2a-d show schematic views of several arrangements of battery compartments in the battery holders.

FIG. 3 shows details of the side wall drafts and air vents in accordance with the embodiments of the present invention.

FIG. 4a shows the plan and perspective views of one embodiment of the battery holder and cap arrangement.

FIG. 4b shows the plan and perspective views of one embodiment of the battery holder and the cap.

FIG. 4c shows a perspective view of the battery holder with the keychain tab.

FIG. 5 shows several views of the battery compartment divider in accordance with one embodiment of the invention.

FIG. 6 shows several options for the full and empty battery indicia.

### DETAILED DESCRIPTION OF THE INVENTION

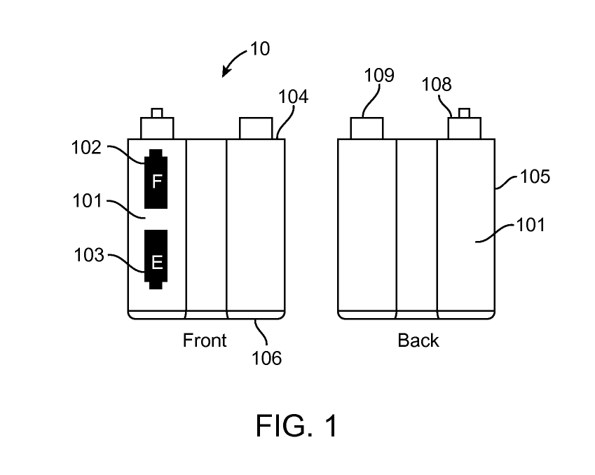

Embodiments of the present invention are directed towards battery holder for portable storage of batteries. The invention is especially well suited for storing a mix of full and empty batteries. The battery holder has indicia that signal proper orientation of the battery insertion into a battery compartment and, consequently, the status of the battery in the battery compartment. The present invention has features that secure batteries inside the battery holder. The details of the exemplary embodiments of the present invention are explained with reference to FIGS. 1-6.

Referring now to FIG. 1, front and back plan views of a battery holder 10 are shown. The battery holder having two battery compartments 101 is illustrated, but battery holders having different numbers of battery compartments are also possible. A full battery indicia 102 and an empty battery indicia 103 are attached with the battery holder to signal usability status of batteries in the battery compartments: a fully charged battery is shown as the battery in the first orientation 108, an empty battery is shown as the battery in the second orientation 109. Many other examples of the usability status of the batteries are possible. The batteries are inserted and removed through an opening 104. The battery holder has walls 105 and bottom 106 to hold batteries inside the battery compartments. The battery holder may be made of different materials. The inventors have found that elastic polymers, in particular polyurethane, work well due to its favorable elastic and frictional properties, but other materials are also possible.

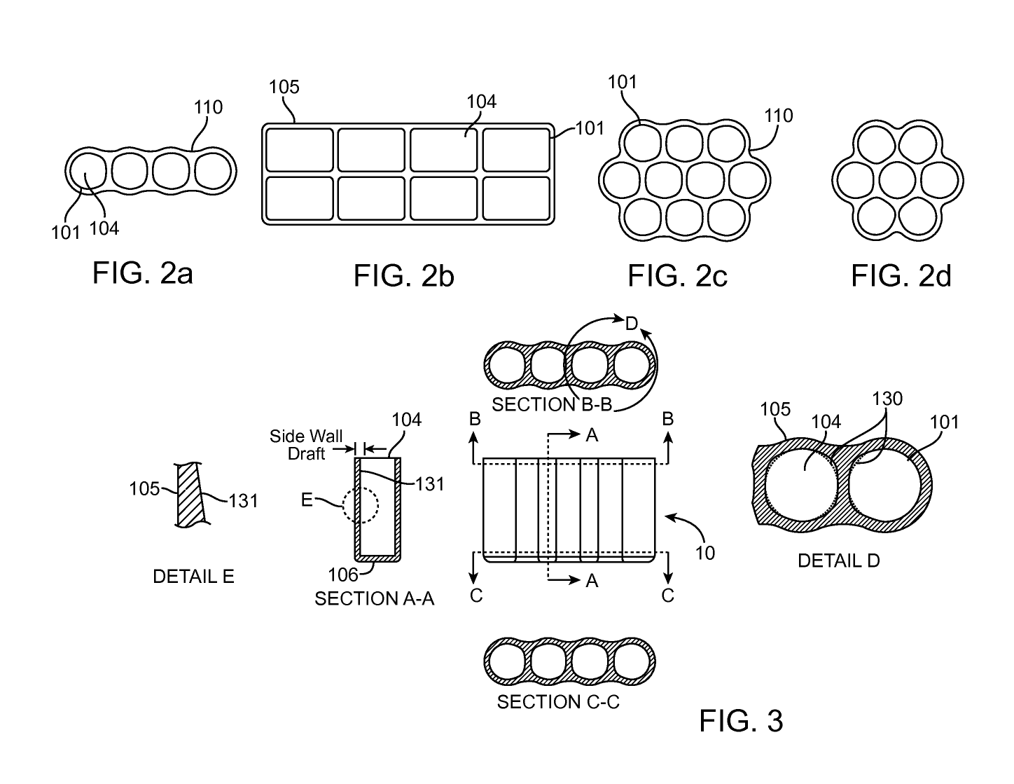

FIGS. 2a-d show top views of several arrangements of the battery compartments in battery holders. FIG. 2a shows a row arrangement of the battery compartments 101 in a battery holder. Four battery compartments in a row are illustrated in FIG. 2a, but other number of battery compartments in a row is also possible. The battery compartments may have undulations 110 for a more ergonomic grip of the battery holder. FIG. 2b illustrates the battery holder which is suitable for the batteries having a rectangular cross section. The battery holder with two rows of the battery compartments 101 is shown in FIG. 2b, but other arrangements of the rows and columns of the battery holder are possible. FIG. 2c shows a honeycomb arrangement of the battery compartments 101 in the battery holder. The battery compartments for the batteries with circular cross section are illustrated, but the battery compartments suitable for the rectangular cross section batteries can also be made in a honeycomb arrangement, as would be clear to a person skilled in the arts. The undulations 110 may be used for a more ergonomic grip of the battery holder. FIG. 2d shows a circular arrangement of the battery compartments in a battery holder.

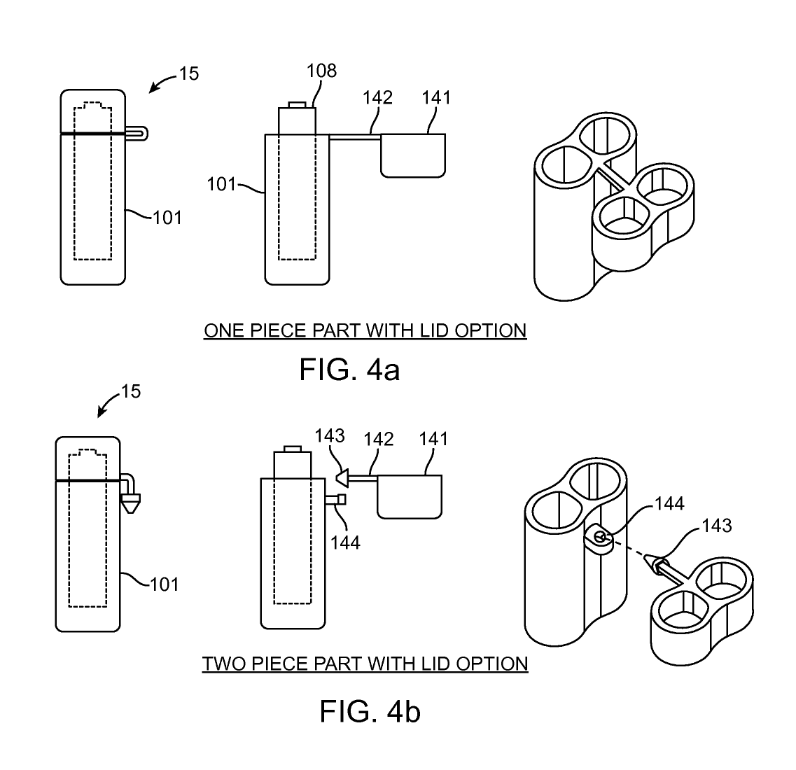

FIG. 3 shows several views of the battery holder 10. An embodiment having four battery compartments in a row is illustrated, but other arrangements of the battery compartments are also possible. Sections B-B and C-C show the cross sectional views of the battery holder 10. Detail D shows additional features of the battery compartments 101. In particular, the battery compartment 101 may have air vents 130, therefore making the opening 104 non-circular. The air vents 130 enable air escape when a circular battery is inserted in or removed from the battery compartment, thus making the insertion and removal easier. Furthermore, the noncircular shape of the opening 104 provides for a better holding of circularly shaped battery inside the battery compartment. It would be clear to a person having ordinary skills in the art that the air vents can also be implemented with a battery holder for the rectangular batteries.

Still referring to FIG. 3, section A-A and detail E (not on scale) show a wall draft 131 of the wall 105 of the battery compartment. The outer surface of the wall 105 is generally vertical, but the inner surface forms a small angle with the outer surface, which, in turn, makes the diameter of the battery compartment at the bottom 106 smaller than at the opening 104. The outer surface of the wall 105 can also be non-vertical, thus providing additional wall draft on the outer surface. Additionally, the diameter of the battery compartment at the bottom 106 can be sized to be slightly smaller than the cross section of the battery. Therefore, when a battery is inserted in the battery compartment 101, the battery will be held in place by the elastic forces of the battery walls 105. Furthermore, the commercially available batteries are known to come in a range of tolerances. Hence, the wall draft 131 makes it possible to hold batteries having somewhat variable true diameter.

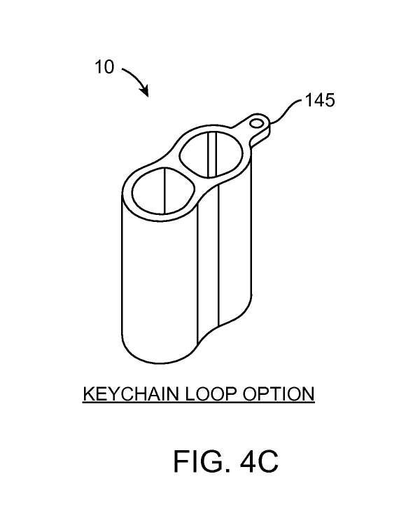

FIGS. 4a-b show several embodiments of the battery holder with a lid. FIG. 4a shows the lid 141 attached to the battery compartment 101 with a connection member 142. The lid 141 can be used to cover the battery in the battery compartment 101, thus additionally securing battery or protecting battery against environment. The lid 141 can be sized to cover one or more battery compartments 101. FIG. 4b shows an embodiment of the battery holder with a removable lid 141. Here, the connecting member 142 of the lid 141 can be connected with the battery holder 101 using a male/female combination of lid anchor 143 and anchor loop 144. Other configurations of the removable lid attachment to the battery holder are also possible, for instance, a different male/female arrangement, a clip connecting the lid with the battery holder, or a chain connecting the lid with the battery holder. FIGS. 4a-b illustrate a battery holder suitable for two cylindrical batteries, but battery holders with different number of battery compartments or those suitable for non-circular batteries are also possible.

FIG. 4c shows an embodiment of the battery holder having a keychain tab 145 suitable for a keychain or similar attachment of the battery holder 10. The keychain tab may be attached at different positions of the battery holder. A battery holder configured for two cylindrical batteries is illustrated, but the battery holders with a different number of battery compartments or for non-circular batteries can also have keychain tab 145.

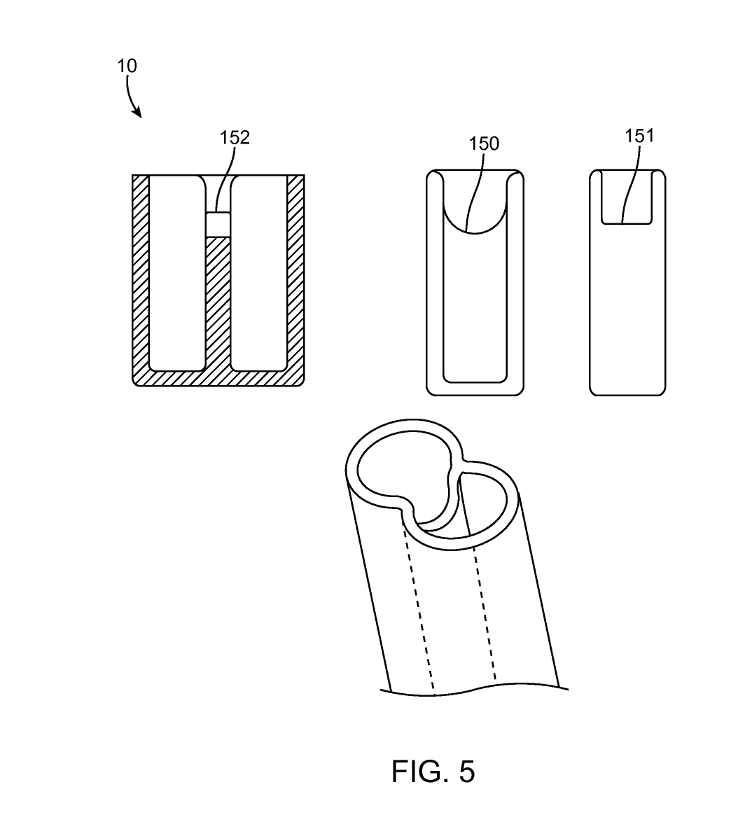

FIG. 5 shows en embodiment of the battery holder 10 having two battery compartments. A battery compartment divider 152 can have a circular cutout 150 or a rectangular cutout 151 for an easier removal of the battery by gently rocking the battery inside the battery holder.

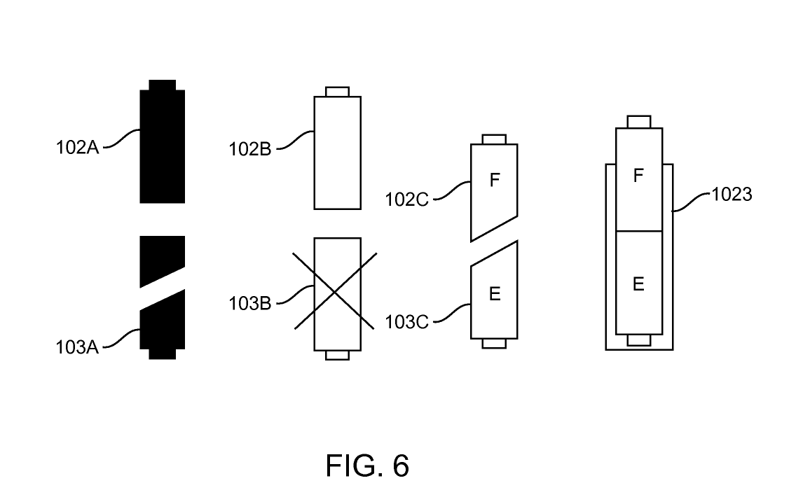

FIG. 6 shows several embodiments of the battery status indicia. Numerals 102A-C illustrate some examples of the indicia showing the battery in the first orientation, i.e. a full battery that is ready for use. Numerals 103A-C illustrate the corresponding battery in the second orientation, i.e. an empty battery that is not ready for use. The battery status indicia can also be combined in a single symbol, as illustrated by numeral 1023. A person skilled in the art would know of many other symbols for indicating battery in the first and second orientation.

As will be understood by those skilled in the art, the present invention may be embodied in other specific forms without departing from the essential characteristics thereof. For example, the battery holder can be made of a transparent or semitransparent material, thus making the battery position immediately clear to a user. Furthermore, a battery holder can be made of the battery compartments suitable for different types and sizes of the batteries, for instance as a combination of AA and AAA battery compartments, or, as another example, combination of cylindrical and non-cylindrical batteries. Additionally, a person skilled in the art would understand that both chargeable and non-chargeable batteries can be used with the invention. Many other embodiments are possible without deviating from the spirit and scope of the invention. These other embodiments are intended to be included within the scope of the present invention, which is set forth in the following claims.

What is claimed is:

1. A device for storing batteries, comprising:
at least one battery compartment for holding a battery further comprising:
an opening for inserting the battery, and
substantially vertical walls for containing the battery; and
a battery orientation indicia affixed to said battery compartment to indicate a first battery orientation for a full battery and a second battery orientation for an empty battery,
wherein the battery is stored in said battery compartment in the first orientation if the battery is full or in the second orientation if the battery is empty.

2. The device of claim 1, wherein said battery orientation indicia is chosen from a group consisting of a battery icon oriented downwards, a battery icon oriented upwards, letter E, letter F, white battery, black battery, green battery, red battery, solid battery icon, hatched battery icon, non-crossed out battery icon, crossed out battery icon, or a combination thereof.

3. The device of claim 1, wherein said battery compartment is made of elastic polymer capable of deforming when the battery is inserted in the compartment, thus securely holding the battery in place.

4. The device of claim 1, wherein said battery compartment is shorter than the battery, thus enabling an end of the battery to stick out to enable easier visual recognition of a type of the battery and whether the battery is full or empty.

5. The device of claim 1, wherein said walls have a wall draft, thus improving a holding grip on the battery inserted into said battery holder.

6. The device of claim 1, wherein said walls are generally cylindrical thus suitable for holding generally cylindrical batteries.

7. The device of claim 1, further comprising one or more air vents for air escape when the battery is inserted or removed, thus making the battery insertion or removal easier.

8. The device of claim 1, wherein an arrangement of said battery compartments is chosen from a group consisting of a honeycomb arrangement, a circular arrangement, two or more substantially parallel columns, or a combination thereof.

9. The device of claim 1, further comprising a cap adapted and configured to engage with said walls around said opening, thus protecting said battery in the battery compartment.

10. The device of claim 9, further comprising a connecting member that connects said cap with said walls.

11. The device of claim 9, wherein said cap is transparent.

12. The device of claim 9, wherein said cap is adapted and configured to create a water tight engagement with said battery compartment.

13. The device of claim 1, wherein said walls have undulations adapted and configured for gripping the battery holder by fingers.

14. The device of claim 1, wherein said walls have cutouts between the adjacent battery compartments for ease of battery removal.

15. The device of claim 14, wherein said cutouts are substantially oval or substantially rectangular.

16. The device of claim 1, wherein said battery holder is made of polyurethane.

17. A method for storing batteries, comprising:
determining full or empty status of a battery,
reading a battery orientation indicia from a battery holder, and
inserting said battery into the battery holder:
in a first direction if said battery is full, or
in a second direction if said battery is empty.

18. A method of claim 17, further comprising attaching a cap on said battery holder, thus further securing said battery in the battery holder.

19. A method for determining full or empty status of batteries, comprising:
ascertaining an orientation of a battery inside a battery holder,
reading a battery orientation indicia from said battery holder, and
comparing said orientation of the battery to said battery orientation indicia to determine if said battery is full or empty.

20. A method of claim 19, further comprising removing a cap from said battery holder.
